(19) United States
(12) Patent Application Publication
(10) Pub. No.: US 2025/0382207 A1
(43) Pub. Date: Dec. 18, 2025

(54) FLOCCULANT FOR REMOVING HEAVY METALS AND METHOD FOR REMOVAL OF HEAVY METALS USING THE SAME

(71) Applicant: ELECTRONICS AND TELECOMMUNICATIONS RESEARCH INSTITUTE, Daejeon (KR)

(72) Inventor: Rae-Man PARK, Daejeon (KR)

(73) Assignee: ELECTRONICS AND TELECOMMUNICATIONS RESEARCH INSTITUTE, Daejeon (KR)

(21) Appl. No.: 19/096,383

(22) Filed: Mar. 31, 2025

(30) Foreign Application Priority Data
Jun. 13, 2024 (KR) 10-2024-0077188

(51) Int. Cl. C02F 1/54; C02F 1/52; C02F 101/20

(52) U.S. Cl. CPC C02F 1/54; C02F 1/5263; C02F 2101/20

(57) ABSTRACT

Provided is a flocculant for removing heavy metals containing a solvent and nano celluloses dispersed in the solvent. The nano celluloses may have a negative surface charge, and an average length of the nano celluloses may be about 0.2 μm to about 1 μm.

### CROSS-REFERENCE TO RELATED APPLICATIONS

This U.S. non-provisional patent application claims priority under 35 U.S.C. § 119 of Korean Patent Application No. 10-2024-0077188, filed on Jun. 13, 2024, the entire contents of which are hereby incorporated by reference.

### BACKGROUND

The present disclosure herein relates to a flocculant for removing heavy metals and a method for removal of heavy metals using the same, and more specifically relates to a flocculant for removing heavy metals containing nano cellulose that is capable of removing toxic heavy metals contained in industrial waste water, sewage, or the like, and a method for removal of heavy metals using the same.

The damage caused by heavy metals, which are one of the sources of water pollution, has been well known for a long time in terms of the seriousness thereof. In a process of the treatment of waste water or sewage, heavy metals are not decomposed or eliminated by microorganisms but are accumulated through the food chain, which has very serious effects on the human body and the ecosystem.

To solve these limitations, various technologies for treating heavy metals in waste water or sewage have been proposed. For example, physical methods such as electrodialysis and electrolysis, as well as chemical methods that precipitate heavy metals by adding chemical drugs, have been proposed.

Recent technologies for a treatment of heavy metals in waste water or sewage are developed in a direction that minimizes treatment costs while efficiently removing heavy metals. In addition, there is a demand for a technology that is capable of effectively removing heavy metals having a low concentration.

### SUMMARY

The present disclosure provides a flocculant for removing heavy metals, containing nano celluloses that is capable of binding to heavy metals, and a method for removal of heavy metals using the same.

The object to be achieved by the embodiment of the inventive concept is not limited to the object mentioned above, and the other objects not mentioned will be clearly understood by those skilled in the art from the description below.

An embodiment of the inventive concept provides a flocculant for removing heavy metals may contain a solvent and nano celluloses dispersed in the solvent. The nano celluloses may have a negative surface charge. An average length of the nano celluloses may be about 0.2 μm to about 1 μm.

In an embodiment, a concentration of the nano celluloses in the flocculant for removing heavy metals may be about 0.01 wt % to about 0.5 wt %.

In an embodiment of the inventive concept, a method for removal of heavy metals using the flocculant for removing heavy metals may include providing waste water containing heavy metal particles; adding a flocculant for removing heavy metals to the waste water; and reacting the flocculant for removing heavy metals with the waste water. The flocculant for removing heavy metals may contain nano celluloses having a negative surface charge.

In an embodiment, each of the heavy metal particles may have a specific gravity of about 6 g/cm³ or more.

In an embodiment, the heavy metal particles may have a positive charge, and the reacting of the flocculant for removing heavy metals with the waste water may include electrostatic binding of the heavy metal particles to surfaces of the nano celluloses.

In an embodiment, the waste water may further contain metal particles other than the heavy metal particles, and the reacting of the flocculant for removing heavy metals with the waste water may further include electrostatic binding to surfaces of the nano celluloses.

In an embodiment, mixing the waste water with the added flocculant for removing heavy metals may be further included after adding the flocculant for removing heavy metals to the waste water, and the mixing of the waste water with the added flocculant for removing heavy metals may be carried out for about 30 seconds to about 20 minutes. The nano celluloses to which the heavy metal particles have been bound may be aggregated with each other to form lumps.

In an embodiment, a recovery process of removing the lumps from the waste water may be further included, and the recovery process may be carried out after the mixing of the waste water with the flocculant for removing heavy metals.

In an embodiment, in the flocculant for removing heavy metals, a concentration of the nano celluloses in the flocculant for removing heavy metals may be about 0.01 wt % to about 0.5 wt %.

In an embodiment, the flocculant for removing heavy metals may have an aqueous solution form of nano celluloses, in which the nano celluloses are dispersed in water.

In an embodiment, the nano cellulose aqueous solution may be produced by a mechanical extrusion process.

In an embodiment, the mechanical extrusion process may use at least one mechanical device of a high-pressure homogenizer, a microfluidizer, or a grinder.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a view illustrating a flocculant for removing heavy metals according to an embodiment of the inventive concept, which shows a process in which a flocculant for removing heavy metals added to waste water reacts with heavy metals in the waste water;

FIG. 2 shows a photographic image of experimental groups of waste water, which contains the flocculant for removing heavy metals according to an embodiment of the inventive concept at different concentrations from each other;

FIG. 3 shows a photographic image captured by enlarging a portion of the experimental groups in FIG. 2;

FIG. 4 shows a photographic image of the experimental groups in FIG. 2, which is captured after the heavy metals in the waste water have been precipitated by the flocculant for removing heavy metals;

FIG. 5 shows a photographic image of a portion of the experimental groups in FIG. 2 after a mixing process;

FIG. 6 shows a captured image using an electron microscope of a first precipitate in FIG. 5;

FIG. 7 shows photographic images of a silver (Ag) aqueous solution and a fourth experimental group to which the flocculant for removing heavy metals according to an embodiment of the inventive concept is added to the silver (Ag) aqueous solution; and

FIG. 8 shows a captured image using an electron microscope of a third precipitate in FIG. 7.

### DETAILED DESCRIPTION

In order to be fully understood the configuration and effects according to the inventive concept, preferred embodiments of the inventive concept are described with reference to the attached drawings. However, embodiments of the inventive concept are not limited to the embodiments described below but can be implemented in various forms, and various changes and modifications can be made. Rather, these embodiments are provided so that the present disclosure described through the embodiments of the inventive concept will be thorough and complete and will fully convey the scope of the inventive concept to those skilled in the art.

The terms used in the present specification are for describing the embodiments and are not intended to limit the present inventive concept. As used herein, singular form also includes plural form unless particularly mentioned otherwise in the text. The terms “comprises” and/or “comprising”, used in the specification do not exclude the presence or addition of one or more other components, steps, operations, and/or devices regarding the mentioned component, step, operation, and/or device. Due to being in accordance with preferred embodiments, the reference numerals presented according to the order of description are not necessarily limited to the order of the description.

Unless otherwise defined, the technical and scientific terms used in the present specification have meanings commonly understood by those skilled in the art to which this inventive concept belongs, and descriptions of known functions and configurations, which may unnecessarily obscure the gist of the inventive concept, are omitted in the following description and accompanying drawings.

### Flocculant for Removing Heavy Metals and Manufacturing Method Therefor

The present disclosure provides a flocculant for removing heavy metals and a method for removal of heavy metals using the same, wherein the flocculant for removing heavy metals contains nano cellulose. The nano cellulose may commonly refer to nano cellulose particles in a fibrous form or a nano crystalline form. Hereinafter, ‘nano cellulose(s)’ and ‘nano cellulose particles’ may be used interchangeably in order to refer to the nano cellulose within the above-described flocculant for removing heavy metals.

The nano cellulose particles may have a fibrous form or a nano crystalline form. The average length of the nano cellulose particles having the above-described fiber form may be about 0.2 μm to about 1 μm. The average length of the nano cellulose particles having the above-described nano crystalline form may be about 100 nm to about 500 nm. However, the embodiment of the inventive concept is not limited thereto, and the form of the nano cellulose may be in various forms such as spherical, fibrous, ribbon-shaped, or plate-shaped.

The raw material of the nano cellulose may not be limited particularly. For example, the main raw material of the nano cellulose may include at least one of wood pulp from a broadleaf tree, a coniferous tree, bamboo, or the like, recycled pulp from old paper, cotton, a skin of sea squirt or warty sea squirt, or a cellulose-shaped substance such as chitin or chitosan.

The flocculant for removing heavy metals according to the present inventive concept may be a nano cellulose dispersion solution that is obtained by dispersing the nano cellulose in a solvent. For example, the solvent may be water. In other words, the flocculant for removing heavy metals may be a nano cellulose dispersion aqueous solution. However, an embodiment of the inventive concept is not limited thereto, and the solvent of the flocculant for removing heavy metals may include a hydrophilic solvent. As necessary, the solvent may contain at least one or more additives such as a surfactant, a pH adjusting agent, and a pH buffer agent.

The flocculant for removing heavy metals may contain nano cellulose manufactured by a mechanical treatment. For example, the main raw material of the nano cellulose may be charged into a mechanical device to carry out a mechanical extrusion process. The mechanical device may include a high-pressure homogenizer, a microfluidizer, a grinder, a high-intensity ultrasonication machine, etc. The mechanical extrusion process may refer to a mechanical treatment process that uses the above-described mechanical device. The mechanical extrusion process may refer to a process of applying high pressure or high temperature to the main raw material of the nano cellulose to obtain nano cellulose. The nano cellulose or a nano cellulose dispersion aqueous solution that is obtained by dispersing nano cellulose in water may be provided by the mechanical extrusion process. The flocculant for removing heavy metals is produced by mechanical treatment, and thus no additional chemical processes are required. As a result, it is possible to provide a flocculant for removing heavy metals, which is obtained through a simplified production process. However, an embodiment of the inventive concept is not limited thereto, and the nano cellulose may be produced in various ways.

In an embodiment according to the inventive concept, the concentration of the nano cellulose in the flocculant for removing heavy metals may be about 0.01 wt % to about 0.5 wt %. An embodiment of the inventive concept is not limited thereto. The concentration of the nano cellulose contained in the flocculant for removing heavy metals may vary depending on the concentration of heavy metals in the waste water that is treated by the flocculant for removing heavy metals.

### Method for Removing Heavy Metals in Waste Water

The waste water to be treated with the flocculant for removing heavy metals may contain heavy metals. The heavy metals may refer to cationic metal components having a specific gravity of about 6 g/cm³ or more but an embodiment of the inventive concept is not limited thereto. The heavy metals may include at least one of nickel, copper, zinc, arsenic, lead, cadmium, cobalt, manganese, or mercury but an embodiment of the inventive concept is not limited thereto. The waste water may include at least one of drain water from waste incineration facilities, drain water from power generation facilities, drain water from steelmaking plants, drain water from plating plants, drain water from dye factories, drain water from other factories, drain water from mining, drain water from construction sites, or other drain water (sewage and the like including even rainwater and the like). However, an embodiment of the inventive concept is not limited thereto, and the waste water may be, for example, ground water (clean water), river water, rainwater, seawater, mud, or the like, which may be any water that is potentially contaminated with heavy metals. In addition, liquids or aqueous dispersion liquids of solid substances (ashes, soil), which contain heavy metals, may be also subjects to be treated with the flocculant for removing heavy metals. As a result, the flocculant for removing heavy metals may be utilized not only in the waste water treatment industry but also in various kinds of industries. For example, the flocculant for removing heavy metals may be utilized in the secondary battery industry. Specifically, the flocculant for removing heavy metals may be utilized to separate metal substances from waste batteries.

The flocculant for removing heavy metals according to the present inventive concept contains nano cellulose having a negative surface charge. Since heavy metals having a positive charge are electrostatically bound to the surface of the nano cellulose, it is possible to efficiently remove heavy metals from the waste water by using the nano cellulose. The flocculant for removing heavy metals contains small-sized nano cellulose particles having an average length of about 1 μm or less, which may increase the total surface area of the nano cellulose particles. Therefore, the heavy metals in the waste water may be efficiently bound to the surface of the flocculant for removing heavy metals. In addition, the concentration of heavy metals in the waste water which is capable of being treated by the flocculant for removing heavy metals may be ranging from a trace amount of about 1 ppm to a high concentration of about 10,000 ppm. The flocculant for removing heavy metals may exhibit high removal efficiency even for heavy metals having a low concentration.

In addition, metal particles excluding heavy metals may also be electrostatically bound to the surface of nano cellulose. In this case, the metal particles may have a positive charge and may contain radioactive isotopes. For example, uranium (U), cesium (Cs), plutonium (Pu), tritium (³H), lithium (Li), and the like may be bound to the surface of the nano cellulose.

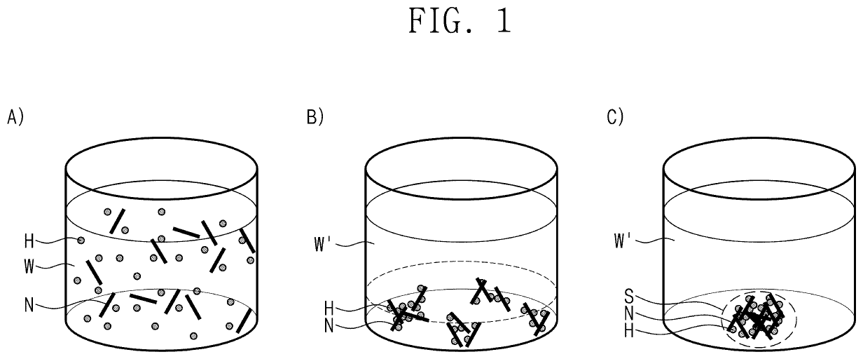

FIG. 1 is a schematic view illustrating a flocculant for removing heavy metals according to an embodiment of the inventive concept, where it shows a process in which a flocculant for removing heavy metals added to waste water reacts with heavy metals in the waste water. First, referring to A) of FIG. 1, waste water (W) containing heavy metal particles (H) may be provided. The heavy metal particles (H) may be cationic metal components having a positive charge. A flocculant for removing heavy metals may be provided in the waste water (W). The flocculant for removing heavy metals may be the above-described flocculant for removing heavy metals and a flocculant for removing heavy metals manufactured according to a method of manufacturing the same. For example, the flocculant for removing heavy metals may contain nano cellulose particles (N) having a negative surface charge.

In this case, the nano cellulose particles (N) in the above-described flocculant for removing heavy metals can react with the heavy metal particles (H) in the waste water (W). Since the nano cellulose particles (N) have a negative surface charge, the heavy metal particles (H) having a positive charge may be electrostatically bound to the surface of the nano cellulose particles (N). The process in which the heavy metal particles (H) are bound to the surface of the nano cellulose particles (N) may be allowed to proceed even in a case where an additional stirring process is not carried out after the flocculant for removing heavy metals has been added to the waste water (W). However, an embodiment of the inventive concept is not limited thereto, and an additional stirring process may be carried out using a stirrer, a vibrator, or the like as necessary. The stirring process may promote a reaction between the nano cellulose particles (N) of the flocculant for removing heavy metals and the heavy metal particles (H).

Referring to B) of FIG. 1, the nano cellulose particles (N) may be precipitated together with the heavy metal particles (H) due to the weight of the heavy metal particles (H) bound to the surface of the nano cellulose particles (N). The waste water (W, see A) of FIG. 1) may be divided into an upper layer and a lower layer by the precipitated nano cellulose particles (N) and the heavy metal particles (H). The lower layer may contain the nano cellulose particles (N) to which the heavy metal particles (H) have been bound. The upper layer may contain waste water (W′) from which heavy metal particles (H) have been removed.

Referring to C) of FIG. 1, a mixing process may be allowed to proceed in B) described above. Through the mixing process, the nano cellulose particles (N) to which the heavy metal particles (H) have been bound may be bound to the adjacent nano cellulose particles (N) to form a lump of a precipitate (S). However, an embodiment of the inventive concept is not limited thereto, and a plurality of the precipitate (S) may be provided. Thereafter, the precipitate (S) is removed, whereby it is possible to obtain the waste water (W′) from which the heavy metal particles (H) have been removed.

Since the nano cellulose particles (N) form the precipitate (S), the removal of the heavy metal particles (H) from waste water (W) may be facilitated. Although not illustrated, the process of adding the above-described flocculant for removing heavy metals into the waste water (W) may be repeated. For example, the flocculant for removing heavy metals may be added again to the waste water from which the precipitate (S) has been removed. The flocculant for removing heavy metals, which has been added again, makes it possible to remove some heavy metals remaining in the waste water. The removing process of heavy metals through the flocculant for removing heavy metals is repeated, which may further reduce the concentration of heavy metals in the waste water to be finally obtained.

### Experimental Example 1. Precipitation Experiment for High-Concentration Industrial Waste Water

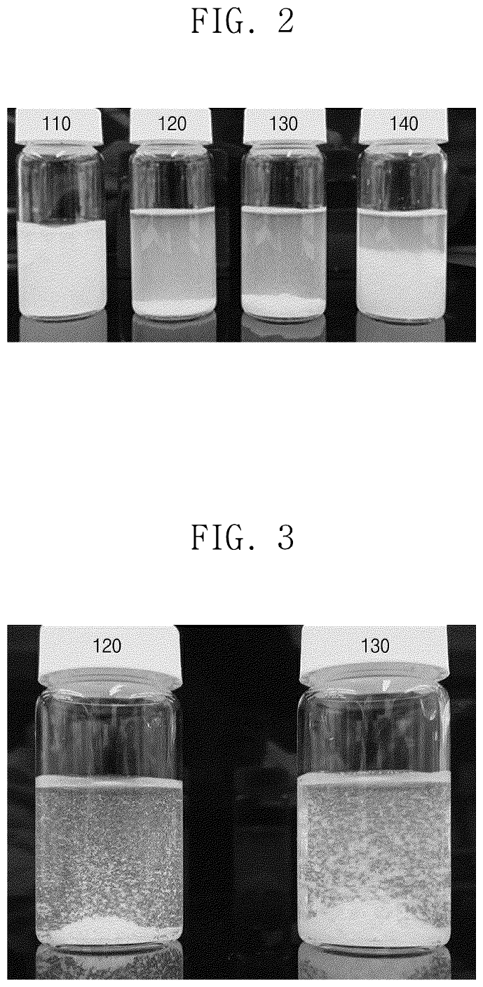

FIG. 2 shows a photographic image of experimental groups of waste water in which the flocculants for removing heavy metals according to an embodiment the inventive concept are contained at concentrations different from each other. Referring to FIG. 2, high-concentration industrial waste water 110 may be provided. In this case, the high-concentration industrial waste water 110 may have a heavy metal concentration of about 8 g/kg to about 9 g/kg. The heavy metals may include at least one among copper (Cu), lead (Pb), aluminum (Al), tellurium (Te), and zinc (Zn).

It is possible to provide a first experimental group to a third experimental group 120, 130, and 140 in which flocculant for removing heavy metals having different concentrations are respectively contained in the high-concentration industrial waste water 110. The flocculant for removing heavy metals may be the above-described flocculant for removing heavy metals of a flocculant for removing heavy metals manufactured according to a method of manufacturing the same. For example, the first to third experimental groups 120, 130, and 140 may be each a nano cellulose dispersion aqueous solution containing nano cellulose particles having a negative surface charge. The first experimental group 120 is obtained by mixing about 11 ml of the high-concentration industrial waste water 110 and about 2 ml of a nano cellulose dispersion aqueous solution having a concentration of about 0.01 wt %. The second experimental group 130 is obtained by mixing about 11 ml of the high-concentration industrial waste water 110 and about 2 ml of a nano cellulose dispersion aqueous solution having a concentration of about 0.05 wt %. The third experimental group 140 is obtained by mixing about 11 ml of the high-concentration industrial waste water 110 and about 2 ml of a nano cellulose dispersion aqueous solution having a concentration of about 0.5 wt %.

Although not illustrated, the flocculant for removing heavy metals before being mixed with the high-concentration industrial waste water 110 may be in a transparent state. For example, nano cellulose particles may be uniformly dispersed in water, thereby being in a state of having no precipitate. However, an embodiment of the inventive concept is not limited thereto.

FIG. 3 shows a photographic image captured by enlarging the first experimental group 120 and the second experimental group 130. FIG. 3 shows a process in which the nano celluloses in the first experimental group 120 and the second experimental group 130 are electrostatically bound to heavy metals to thereby be precipitated. It can be confirmed that the nano cellulose particles bound to the heavy metal particles are bound to adjacent nano cellulose particles at the lower part of the first experimental group 120 and the second experimental group 130, and thus a precipitate is formed. As the concentration of nano cellulose in the flocculant for removing heavy metals increases, the nano cellulose particles bound to heavy metals may be more easily bound to adjacent nano cellulose particles. For example, as shown in FIG. 3, in the second experimental group 130, the size of the precipitates formed by the aggregation of the nano cellulose particles bound to the heavy metal particles (H) may be larger than the size of the precipitates in the first experimental group 120.

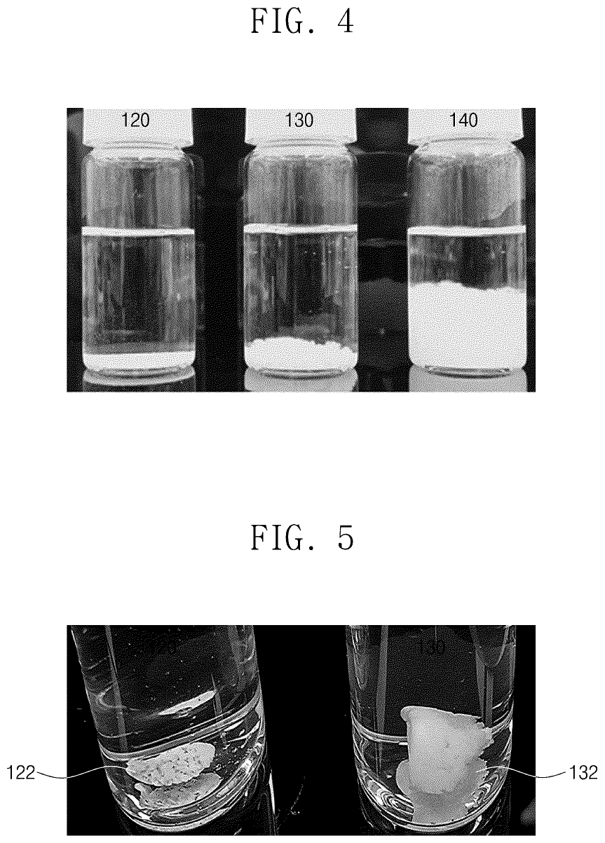

FIG. 4 shows a photographic image of the first to third experimental groups 120, 130, and 140, captured after a reaction time of about 1 hour. As seen in FIG. 4, it can be confirmed that the first to third experimental groups 120, 130, and 140 each have a two-layered structure. Each of the first to third experimental groups 120, 130, and 140 may be divided into an upper layer containing waste water in which at least a portion of heavy metals are removed and a lower layer containing nano cellulose bound to the at least some portion of heavy metals. For example, the above-described photographic image may be similar to the state of B) of FIG. 1. The heavy metals are bound to the surface of each nano cellulose particle, and the nano cellulose particles may be precipitated while being aggregated with each other. As a result, the concentration of heavy metals in the upper layer solution may be lower than the concentration of heavy metals in the high-concentration industrial waste water 110. In addition, it can be confirmed that, unlike the high-concentration industrial waste water 110 and the first to third experimental groups 120, 130, and 140 in FIG. 2, which showed a cloudy color due to heavy metals, the upper layer solutions of the first to third experimental groups 120, 130, and 140 become transparent. In the description of FIG. 4, each of the first to third experimental groups 120, 130, and 140 has the above-described two-layered structure after a reaction time of about 1 hour, but the reaction time required for the process in which the nano cellulose particles are precipitated may vary.

### Experimental Example 2. Experiment of Formation of Heavy Metal Precipitate

FIG. 5 shows a captured photographic image after the first and second experimental groups 120 and 130 of Experimental Example 1 have been subjected to the mixing process. Specifically, the first and second experimental groups 120 and 130 in FIG. 4 may be subjected to the mixing process. For example, the first and second experimental groups 120 and 130 may be stirred for about 30 seconds and then may be stirred again for about 30 seconds after a certain period of time has elapsed. The stirring may be carried out about 3 to 5 times for about 20 minutes. However, an embodiment of the inventive concept is not limited thereto, and the time and the number of times of stirring in the mixing process may vary as necessary. As shown in FIG. 5, it can be confirmed that each of the first and second precipitates 122 and 132 are formed in each of the first experimental group 120 and the second experimental group 130 through the mixing process. The first and second precipitates 122 and 132 may be each a lump in which the nano cellulose particles bound to heavy metals are aggregated through the mixing process. As described with reference to FIG. 4, heavy metals may be bound to the surface of nano cellulose particles, thereby being precipitated. While precipitating, the nano cellulose particles bound to the heavy metal particles may be aggregated with adjacent nano cellulose particles. The bound nano cellulose particles may form one lump or a plurality of lumps through the mixing process. Since nano cellulose forms a lump in this way, the heavy metals may be easily separated from waste water by removing the aggregated nano cellulose lump.

The concentrations of the removed heavy metals for the first and second experimental groups 120 and 130 may be calculated using Equation 1 below.

$${q}_{e} = ( Co - Ce ) V / m \qquad Equation 1$$

In Equation 1 above, qₑ is the maximum binding capacity (mg/g) of heavy metals, Co is the initial concentration (mg/L) of heavy metals in waste water, Ce is the concentration (mg/L) of heavy metals at equilibrium after the addition of the flocculant for removing heavy metals, m is the mass (g) of the flocculant for removing heavy metals, and V is the volume (L) of waste water. The maximum binding capacity of heavy metals relative to the weight of nano cellulose, which is calculated using Equation 1 above, may be about 600 mg/g at maximum. As described above, it can be confirmed that a large amount of heavy metals may be effectively removed with nano cellulose having a small concentration.

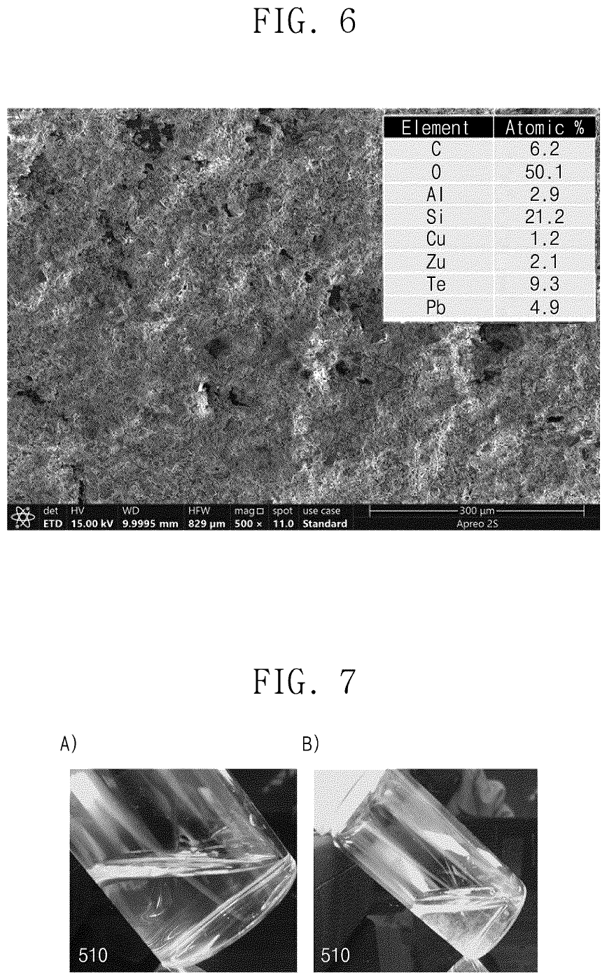

FIG. 6 is a photographic image of the first precipitate 122 in FIG. 5, as captured with a scanning electron microscope (SEM). As shown in FIG. 6, the nano cellulose particles to which heavy metal particles have been bound electrostatically may be aggregated with each other to constitute the first precipitate 122 in FIG. 5. A table in the upper right corner of FIG. 6 shows the elemental composition ratio of the first precipitate 122. As shown in the table above, the first precipitate 122, which is a nano cellulose aggregate to which heavy metals have been bound, may contain heavy metal particles such as aluminum (Al), tellurium (Te), lead (Pb), zinc (Zn), and copper (Cu).

### Experimental Example 3. Precipitation Experiment for Silver (Ag) Aqueous Solution

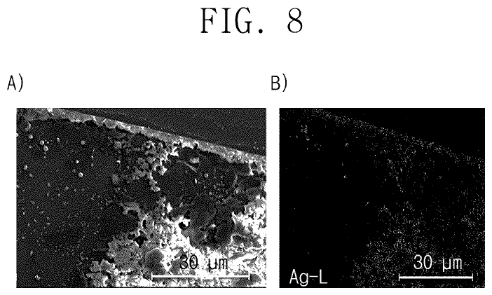

FIG. 7 shows photographic images of a fourth experimental group 510 of a silver (Ag) aqueous solution and a silver (Ag) aqueous solution to which the flocculant for removing heavy metals according to an embodiment the inventive concept has been added. Referring to A) in FIG. 7, a fourth experimental group 510 may be provided. The fourth experimental group 510 is obtained by mixing about 2 ml of a flocculant for removing heavy metals having a concentration of about 0.01 wt % in a silver (Ag) aqueous solution having a low concentration of about 2.2 mg/kg. The flocculant for removing heavy metals may be the above-described flocculant for removing heavy metals and a flocculant for removing heavy metals manufactured according to a method of manufacturing the same. B) in FIG. 7 is an image of the fourth experimental group 510, as captured after a reaction time of about 10 minutes. The fourth experimental group 510 may contain a third precipitate. The third precipitate may refer to a precipitate in which silver (Ag) particles are bound to the nano cellulose in the flocculant for removing heavy metals. Although not illustrated, the fourth experimental group 510 may have a layered structure as shown in FIG. 4 when the reaction time increases. For example, the fourth experimental group 510 may be divided into an upper layer containing waste water in which at least a portion of silver (Ag) is removed and a lower layer containing nano cellulose to which the at least a portion of the silver (Ag) is bound. The fourth experimental group 510 having the layered structure may be subjected to the mixing process as shown in FIG. 5. When the mixing process is allowed to proceed, although not illustrated, the third precipitate may form a lump as in the case of the first and second precipitates 122 and 133 in FIG. 5.

FIG. 8 is a photographic image of the third precipitate of B) in FIG. 7, as captured with a scanning electron microscope (SEM). B) in FIG. 8 shows an image in which the silver (Ag) particles are highlighted in the photographic image of A) in FIG. 8. As illustrated, the presence of the silver (Ag) particles bound to the surface of nano cellulose can be confirmed. Therefore, the flocculant for removing heavy metals according to an embodiment of the inventive concept may be effective in a low concentration of metals.

The flocculant for removing heavy metals according to an embodiment of the inventive concept contains nano cellulose, and thus heavy metal particles may be electrostatically bound to the nano cellulose. As a result, the flocculant for removing heavy metals, which is capable of efficiently removing heavy metals may be provided.

The flocculant for removing heavy metals according to an embodiment of the inventive concept contains nano cellulose having a negative surface charge, and thus a flocculant for removing heavy metals, which is capable of removing not only heavy metals but also other radioactive metals having a positive charge in waste water may be provided.

Hitherto, although the embodiments of the present inventive concept have been described with reference to the attached drawings, it is understood that the present inventive concept should not be limited to these embodiments, but various changes and modifications can be made by one ordinary skilled in the art within the spirit and scope of the present inventive concept as hereinafter claimed. Therefore, it should be understood that the embodiments described above are illustrative in all aspects and not restrictive.

What is claimed is:

1. A flocculant for removing heavy metals, comprising:
a solvent; and
nano celluloses dispersed in the solvent,
wherein the nano celluloses have a negative surface charge, and
an average length of the nano celluloses is about 0.2 μm to about 1 μm.

2. The flocculant for removing heavy metals of claim 1, wherein a concentration of the nano celluloses in the flocculant for removing heavy metals is about 0.01 wt % to about 0.5 wt %.

3. A method for removal of heavy metals, comprising:
providing waste water containing heavy metal particles;
adding a flocculant for removing heavy metals to the waste water; and
reacting the flocculant for removing heavy metals with the waste water,
wherein the flocculant for removing heavy metals contains nano celluloses having a negative surface charge.

4. The method for removal of heavy metals of claim 3, wherein each of the heavy metal particles has a specific gravity of about 6 g/cm³ or more.

5. The method for removal of heavy metals of claim 3,
wherein the heavy metal particles have a positive charge, and
the reacting of the flocculant for removing heavy metals with the waste water includes electrostatically binding the heavy metal particles to surfaces of the nano celluloses.

6. The method of claim 5,
wherein the waste water further contains metal particles other than the heavy metal particles, and
the reacting of the flocculant for removing heavy metals with the waste water further includes electrostatically binding the metal particles to the surfaces of the nano celluloses.

7. The method of claim 5,
further comprising a mixing process of the waste water with the added flocculant for removing heavy metals, after adding the flocculant for removing heavy metals to the waste water,
wherein the mixing process of the waste water with the added flocculant for removing heavy metals is carried out for about 30 seconds to about 20 minutes, and
the nano celluloses to which the heavy metal particles are bound are aggregated with each other to form lumps.

8. The method of claim 7, further comprising a recovery process of removing the lumps from the waste water,
wherein the recovery process is carried out after the mixing process of the waste water with the flocculant for removing heavy metals.

9. The method of claim 3, wherein in the flocculant for removing heavy metals, a concentration of the nano celluloses is about 0.01 wt % to about 0.5 wt %.

10. The method of claim 3, wherein the flocculant for removing heavy metals has a nano cellulose aqueous solution form, in which the nano celluloses are dispersed in water.

11. The method of claim 10, wherein the nano cellulose aqueous solution is produced by a mechanical extrusion process.

12. The method of claim 11, wherein the mechanical extrusion process uses at least one mechanical device of a high-pressure homogenizer, a microfluidizer, or a grinder.
